(19) United States
(12) Patent Application Publication
(10) Pub. No.: US 2010/0269944 A1
(43) Pub. Date: Oct. 28, 2010

(54) FLEXIBLE DUCT AND THE PRODUCTION THEREOF

(76) Inventors: Stephen Robert Wilson, Mt. Waverley (AU); Timothy Craig, Mt Waverley (AU)

Correspondence Address: GREER, BURNS & CRAIN, 300 S WACKER DR, 25TH FLOOR, CHICAGO, IL, 60606, US

(21) Appl. No.: 12/810,392

(22) PCT Filed: Dec. 24, 2008
(86) PCT No.: PCT/AU2008/001917

§ 371 Date: Jun. 24, 2010

(30) Foreign Application Priority Data
Dec. 24, 2007 (AU) 2007907095

(51) Int. Cl. F16L 11/20; F16L 11/00; B65H 81/00; B32B 37/02

(52) U.S. Cl. 138/129; 138/137; 156/187; 156/425; 156/62.2; 156/494; 138/149

(57) ABSTRACT

A flexible duct including: a first, inner layer that includes multiple helical windings of a strip of thin flexible material; a second layer overlying and adhered to the first, inner layer and including multiple helical windings of a tube containing insulating material; and a helically wound reinforcing element.

### FIELD OF THE INVENTION

This invention relates to ducting and, more particularly, to an improved flexible duct construction of the kind suitable for use in ducted heating and air conditioning systems. The invention also relates to a method of and apparatus for manufacturing such a duct.

### BACKGROUND OF THE INVENTION

Many different forms of duct constructions have been used in the past for heating and air conditioning duct construction, as well as in the construction of ducts for ventilation and air extraction systems.

Most previously proposed flexible duct constructions have a non-insulating core and require further processing to attach or contain an insulating medium such as fibreglass or a blanket of polyester fibre with a sheath of plastic or aluminium film being required to complete the duct.

In U.S. Pat. No. 5,210,947, there is described a flexible duct construction and method of manufacture in which a helically wound wire reinforcing element is embedded into the inner surface of a tubular casing of foam plastics. Such a duct construction has good insulating properties but can be expensive to manufacture, requiring the electrically conductive wire to be heated to soften the internal wall of the foam casing to embed the wire in the foam casing. Moreover, it is effectively not compressible axially for transport and storage—a major cost disadvantage—and its flexibility, for forming bends in the duct, is quite limited.

Australian patent 773565 discloses a flexible tubular duct comprising a strip of flexible substrate material formed to have a rounded P-shaped encapsulating portion which encapsulates a core of insulating material. The rounded encapsulating portion is helically wound to form the tubular duct. The duct also includes a helically wound reinforcing element which is encapsulated by the strip of substrate material in the tubular duct. Also disclosed is a concept of applying heat or pressure to the radially outer part of the encapsulating portion to allow this outer part to stretch as the rounded portion is helically wound up to form the duct.

International patent publication WO 2005/106315 describes a modification of the duct of patent 773565 in which the core of insulating material comprises fibrous matter introduced into the rounded encapsulating portion by entrainment in an air stream.

These prior duct constructions, and their associated methods of manufacture, have been found to involve a number of practical disadvantages. The overlapping of successive P-shaped windings to achieve a unified structure is attractive for its single winding operation. However, key issues include the practical difficulties encountered in stretching the outer diameter and in applying glues, at production speeds required for an economically viable duct output. Additionally, the formation of the strip of flexible substrate material into a rounded P-shaped encapsulating portion requires a somewhat lengthy “run-up” to the winding mandrel.

It is an object of the invention to provide an insulated flexible duct that is practical to manufacture in large volumes at high rates of production, and further to provide an improved method of manufacturing of such ducts.

It is not admitted that any of the information in this specification is common general knowledge, or that the person skilled in the art could be reasonably expected to have ascertained, understood, regarded it as relevant or combined it in anyway at the priority date.

### SUMMARY OF THE INVENTION

In the first aspect of this invention there is provided a flexible duct including:

a first, inner layer that includes multiple helical windings of a strip of thin flexible material;

a second layer overlying and adhered to said first, inner layer and including multiple helical windings of a tube containing insulating material; and

a helically wound reinforcing element.

Preferably at the outer periphery of each winding of the tube, the tube remains substantially unstretched and uncompressed circumferentially, while at the inner periphery the tube is puckered circumferentially.

The insulating material is preferably a mass of loose fibrous material.

The second layer is adhered to the first, inner layer. Preferably, for enhanced flexibility of the duct, adjacent windings of the tube are not adhered together, although they are typically in contact.

Preferably, the helically wound reinforcing element is in contact with the first, inner layer, most preferably by being captured between overlapping portions of adjacent windings. The reinforcing element may typically be a wire.

Optionally, the duct may further include a third, outer layer comprising an envelope or encasement that is preferably moisture impermeable. This may be necessary, for example, where the tube material is not moisture impermeable.

The tube may be air permeable, e.g. by being perforated, to allow excess air to escape during introduction of the insulating material by entrainment in the air and/or to allow air to subsequently pass in and out of the interior of the tube, whereby to render the duct more compressible longitudinally or axially.

The thin flexible material of the first, inner layer may conveniently be polyester, e.g. metallised polyester. The material of the tube is preferably a flexible polymer plastics film, for example polyester, polyethylene or polypropylene.

Preferably, the duct is compressible longitudinally or axially, in the ratio of at least 4:1, more preferably 5:1 and most preferably 6:1, to facilitate storage and transport.

In a second aspect of the invention there is provided a method of forming a flexible duct that includes helically winding a tube containing insulating material, wherein the tube is delivered into its initial winding at a rate so that at the outer periphery of the winding the tube remains substantially unstretched and uncompressed circumferentially, while at the inner periphery the tube is allowed to pucker circumferentially.

The aforesaid rate of delivery may be achieved by engaging said outer periphery with at least one press wheel that drives the outer periphery onto a mandrel assembly that helically winds the tube to form the duct, the rates of rotation of the press wheel and mandrel assembly being synchronised so that at the outer periphery of the winding the tube remains substantially unstretched and uncompressed circumferentially, while at the inner periphery the tube is allowed to pucker circumferentially.

Preferably, the method of the second aspect of the invention is utilised to form the second layer of a flexible duct according to the first aspect. To that end, the insulating material is preferably a mass of loose fibrous insulating material. Advantageously, the second layer is adhered to the first layer. Preferably, for enhanced flexibility of the duct, adjacent windings of the tube are not adhered together, although they are typically in contact.

In its second aspect, the invention also provides apparatus for forming a flexible duct, including:

a mandrel assembly to helically wind a tube containing insulating material;

means to engage the outer periphery of the tube to drive it onto the mandrel assembly; and

means to synchronise said engagement means with the rate of rotation of the mandrel assembly so that at the outer periphery of the winding the tube remains substantially unstretched and uncompressed circumferentially, while at the inner periphery the tube is allowed to pucker circumferentially.

In a third aspect of the invention there is provided a method of forming an insulating tube, including the steps of:

drawing a strip of flexible material relatively laterally of and into a forming head that delivers the strip forwardly from the forming head as a tubular casing in the direction of the axis of the casing, and

delivering fibrous insulating material into said casing at said forming head as a gas-entrained stream of the material;

The invention also provides, in its third aspect, apparatus for forming an insulating tube, including:

a forming head;

means to draw a strip of flexible material relatively laterally of and into the forming head which is configured to deliver the strip forwardly from the forming head as a tubular casing in the direction of the axis of the casing; and

means to deliver fibrous insulating material into said casing at said forming head as a gas-entrained stream of the insulating material.

In its second aspect, the flexible material of the strip is preferably air permeable, e.g. by being perforated, to allow excess air to escape during introduction of the insulating material by entrainment in the air.

The invention also extends to a method according to the second aspect in which the tube is formed according to the third aspect.

The invention still further provides, in a fourth aspect, a method of forming a flexible duct, including:

forming an insulating tube according to the third aspect of the invention;

helically winding a strip of flexible material into multiple windings as a first, inner layer;

helically winding the tube to form a second layer overlying and adhered to the inner layer, wherein the tube is delivered into its initial winding at a rate so that at the outer periphery of the winding the tube remains substantially unstretched and uncompressed circumferentially, while at the inner periphery the tube is allowed to pucker circumferentially; and

helically winding a reinforcing element associated with said first and/or second layer.

### BRIEF DESCRIPTION OF THE DRAWINGS

The invention will now be further described, by way of example only, with reference to the accompanying drawings, in which:

FIG. 1 is a somewhat schematic front elevational view of apparatus for forming a flexible duct, depicting the principal components constituting preferred embodiments of the various aspects of the invention and showing the apparatus in operation;

FIG. 2 is an isometric view of the tube forming station and part of the winding station of the apparatus depicted in FIG. 1, also showing a partly formed duct;

FIG. 3 is a different partial isometric view of the winding station, not in operation;

FIG. 4 is a cross section on the line 4:4 in FIG. 1;

FIG. 5 is an enlarged fragmentary cross-section showing the duct structure; and

FIG. 6 is a cross-section on the line 6-6 in FIG. 1.

### DETAILED DESCRIPTION OF THE EMBODIMENTS

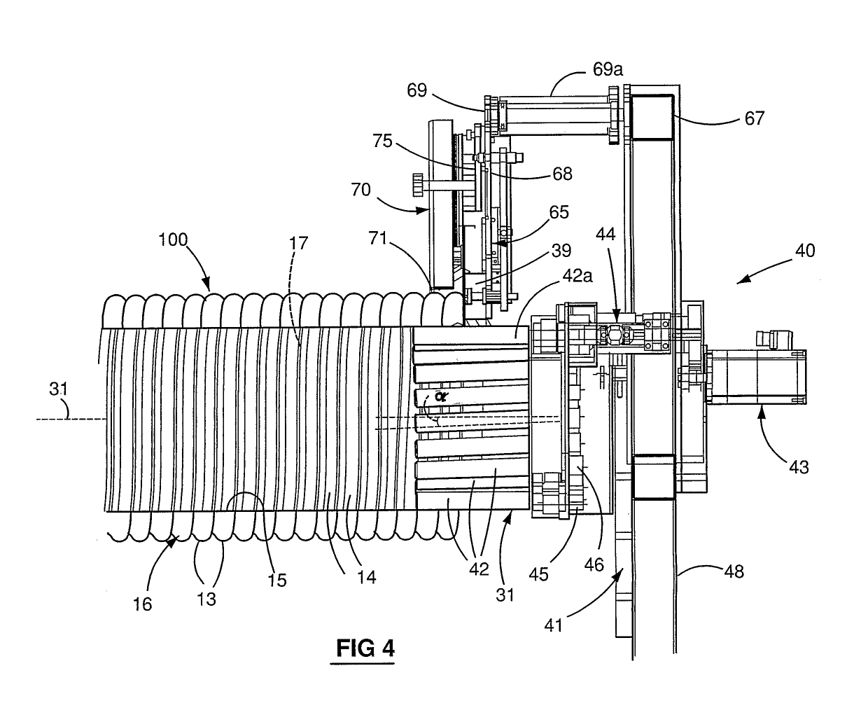

The illustrated duct forming apparatus 10 broadly includes a tube forming station 20 at which polymer plastics strip 12 and gas-entrained fibrous insulating material are brought together to form an insulating tube or “sausage” 13, and a winding station 30 incorporating a mandrel 32 at which metallised polyester strip 14 and the insulating tube 13 are successively helically wound to form insulated flexible duct 100 according to a preferred embodiment of the first aspect of the invention. The other principal components visible in the drawings include a delivery system 50 for the polyester strip 14, a wire feed device 60 for delivering reinforcing wire 17 that is also helically wound into the duct at winding station 30, duct severing units 70,72, and a drive system 40 for winding station 30 (FIG. 4).

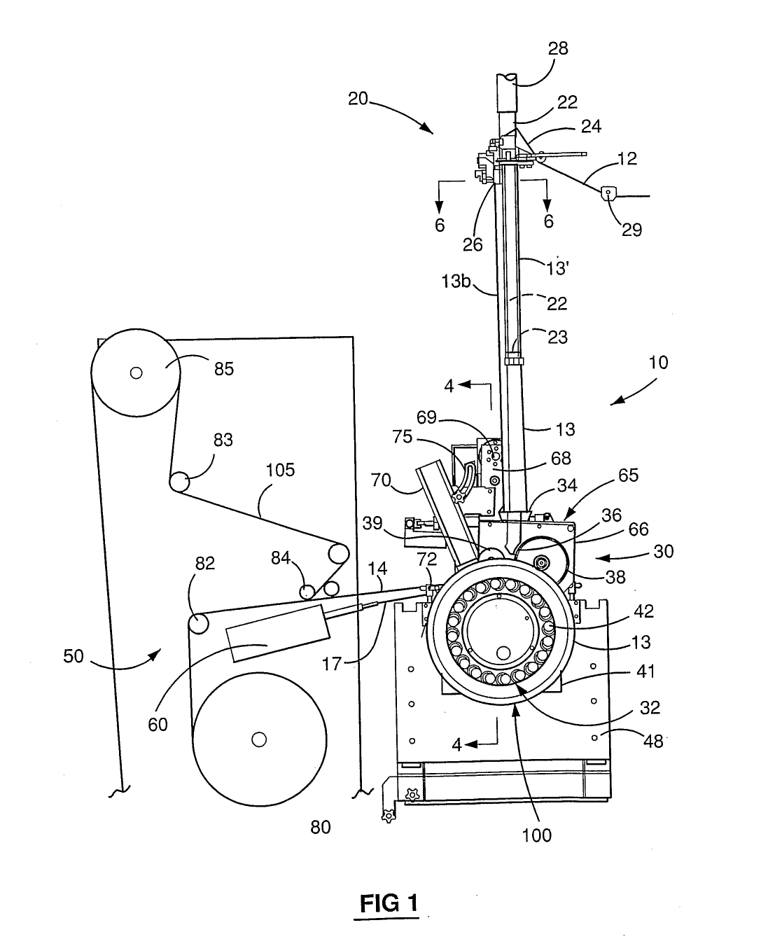

Tube forming station 20 includes a vertically depending pipe 22 and, fitted about the pipe near its upper end, a forming head 24 that receives flat polymer plastics film or strip 12 from the side via guide rollers 29 and shapes it into a flexible tube 13′ vertically descending about pipe 22. In operation, as will be seen, the tube 13′ is drawn downwardly about the pipe and thus the strip is continuously drawn onto and over the forming head 24 and shaped into the tube as it does so. For clarity, tube 13′ is depicted in FIG. 1 as if it is transparent (to render pipe 22 visible), but in reality it will be opaque.

Strip 12 may be polyester, polyethylene, polypropylene or other suitable material, but is herein described as a polymer strip. In some cases strip 12 may need to be compatible with inner strip 14, e.g. both comprising a polyester material.

Strip 12 is pre-prepared in an edge margin adjacent each edge of one surface with a respective narrow overlay stripe of a contact adhesive. Forming head 24 shapes the strip so that these two stripes come into face to face contact as a radially projecting flange 13b of the tube. The stripes are pressed together to activate the adhesive and so bond the edge margins together as the tube is delivered forwardly, by being pinched in the nip of a pair of rollers 26 positioned just below forming head 24. This structure is best illustrated in FIG. 6.

In an alternative arrangement that does not employ stripes of contact adhesive, the flange 13b may be formed, and the edge margins bonded together, by ultrasonically welding the edge margins of the strip 12; for this purpose rollers 26 could be replaced by an ultrasonic welding head.

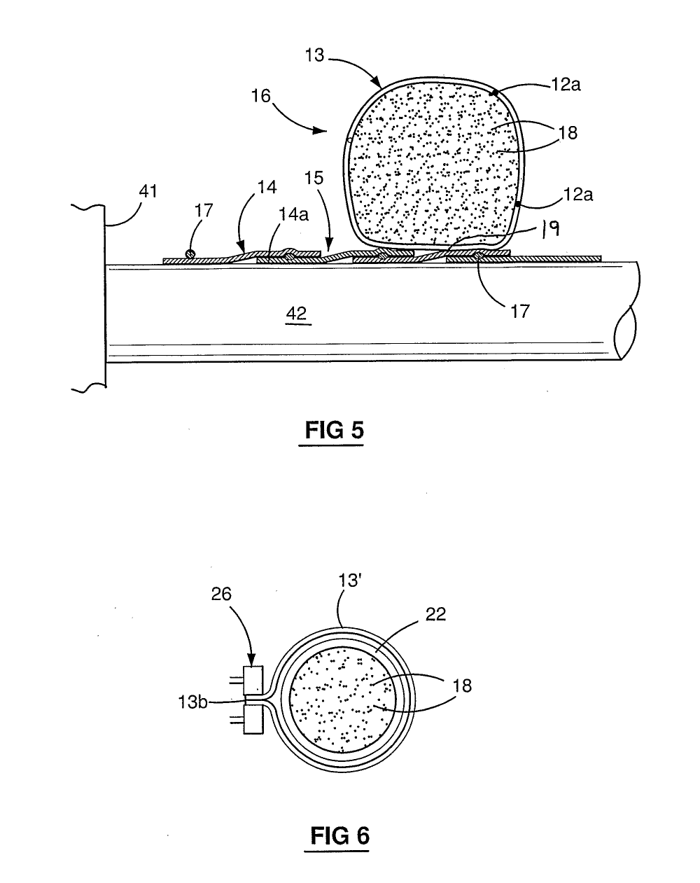

The polymer strip 12 formed into tube 13′ is perforated or pre-formed with an array of pin holes 12a (FIG. 5) that allow air to correctly pass in and out of the strip. Tube forming station may conveniently be provided by a rotary bag forming machine such as a Robag® machine, modified as illustrated to produce a continuous polymer tube rather than a succession of closed bags.

Pipe 22 is coupled at its upper end to a flexible conduit 28. Loose fibrous insulation 18 (only visible in FIG. 5) is entrained in an air stream delivered along conduit 28 and down pipe 22 to emerge from the open lower mouth 23 of pipe 22 into the interior of flexible tube 13′ to form a core or filling for the tube. Tube 13′ therefore now becomes a flexible insulating tube 13. Generation and delivery of the air stream entrained with fibrous insulation may be effected with any appropriate equipment, but a suitable pump for the purpose is described in the present applicant's international patent publication WO 2005/106315. It will also be appreciated that there will be associated plant for supplying the pump with suitably opened and treated fibre initially separated from large rolls or bales of the material.

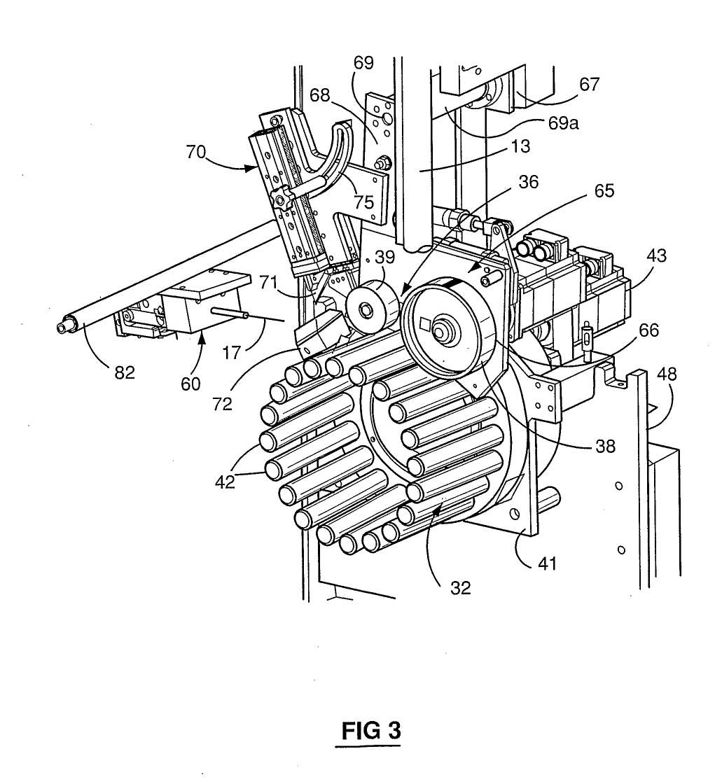

Flexible insulating tube 13 with its core of loose fibrous insulating material continues to descend from forming station 20 to winding station 30. It passes through a guideway (not shown), which flattens flange 13b against the tube body, into an adjustable funnel 34 (not shown in FIG. 3) that delivers the tube to the nip 36 between a larger press wheel 38 and a smaller guide wheel 39 just above mandrel 32. Mandrel 32 includes a support assembly 41 on a pedestal frame, 48 from which projects a ring of multiple close-spaced rotatably mounted rolls 42. Rolls 42 Project cantilever fashion from the annular support assembly in a direction slightly angularly askew of the axis 31 of the support assembly. This angular offset is depicted at a in FIG. 4. With this arrangement, anything delivered to and wound about the ring of rolls 42 as they are rotated by a rear-mounted motor 43, will move forwardly in a helically wound fashion and thereby form a tube or duct 100.

In this case, three separate items are delivered to the winding station to be wound up helically in a multilayer structure. A first or inner layer 15 comprises helically wound metallised polyester strip 14 drawn from a supply package 80 about a succession of guide rolls 82. The face of this polyester strip 14 that will face outwardly is coated with a pressure sensitive contact adhesive that is overlayed with a protective peel-off film 105 in its pre-manufactured form. When the polyester strip 14 is initially manually drawn into position about rolls 82 to the mandrel, peel-off film 105 is separated at a roller nip 84 and drawn back through further guide rolls 83 onto a recovery package 85. Polyester strip 14 can now be wound up helically with a degree of overlap, sufficient tension being applied in the drawing of the strip to apply the pressure necessary to activate the adhesive and to thereby secure the inner layer as an integral inner “duct”.

The second helically wound component of the duct is a reinforcing wire 17 that is delivered by wire feed device 60 into the initial overlap winding 14a of the inner layer 15 (FIG. 5). A reinforcement wire of this kind is a known feature of flexible ducts and ensures the structural and shape integrity of the duct notwithstanding its flexibility and compressibility.

The third helically wound component is the insulating tube 13 which is delivered from nip 36 onto the inner layer so as to form a helically wound second or outer layer 16. The tube is of course being laid on the exposed adhesive of the inner layer and the application of pressure to the tube sufficient to activate the adhesive to secure the tube to the inner layer at interface 19 (FIG. 5) is one of the purposes of press-wheel 38. The other purpose relates to the problem arising from the substantial diameter of tube 13 radially of the duct into which it is being wound. The outer periphery must travel a substantially greater distance than the inner periphery, in forming the initial winding. Conventional approaches to this problem involve either a complex tube structure in which the outer periphery is stretchable or, in the case of the process described in the aforementioned international patent publication WO 2005/106315, heating of the outer periphery to allow it to stretch for winding, using a line of suitable irradiators.

In accordance with the second aspect of the present invention, tube 13 is delivered into the initial winding on the mandrel at a rate so that, at the outer periphery of the winding, the tube remains substantially unstretched and uncompressed circumferentially, while at the inner periphery the tube is allowed to pucker circumferentially. The first arm of this approach is achieved by synchronising the speed of rotation of press-wheel 38 to appropriately match the speed of rotation of the mandrel rolls 42, set according to the radius of the outer periphery of the tube relative to the mandrel axis. The puckering of the inner periphery consequentially follows and the surprising feature of this aspect of the invention is that, despite the puckering of the inner periphery, the adhesion between this inner periphery and the inner layer is entirely adequate for achieving structural integrity in the formed duct.

To ensure that press-wheel 38 applies sufficient but not excessive contact pressure, and is also adjustable to suit different sizes of tube 13, the wheels 38,39 and the funnel 34 are provided in a self-contained pivotable sub-assembly 65. Sub-assembly 65 comprises a pair of spaced plates 66 between which wheels 38,39 are rotatably mounted, and between which funnel 34 is fitted for lateral adjustment, by a small actuator, not shown, relative to nip 36. The rear corner of the sub-assembly, i.e. the corner above wheel 39, has an upstanding arm 68 by which the whole sub-assembly swings from a pivot point 69 located at the outer end of a tubular arm 69a cantilevered from a frame component 67 well above the sub-assembly. It will be appreciated that this arrangement ensures that, under gravity, the sub-assembly 65, and press wheel 38 in particular, will self-adjust to a position that accommodates the winding tube 13 between it and the ring of rolls 42 and applies a sufficient weight-bearing contact pressure to activate the adhesive on the inner layer 15. At the same time, this weight-bearing contact will control the speed of movement of the outer periphery of the tube in its initial winding so that it can match the rotation of rolls 42 as required in accordance with the second aspect of the invention.

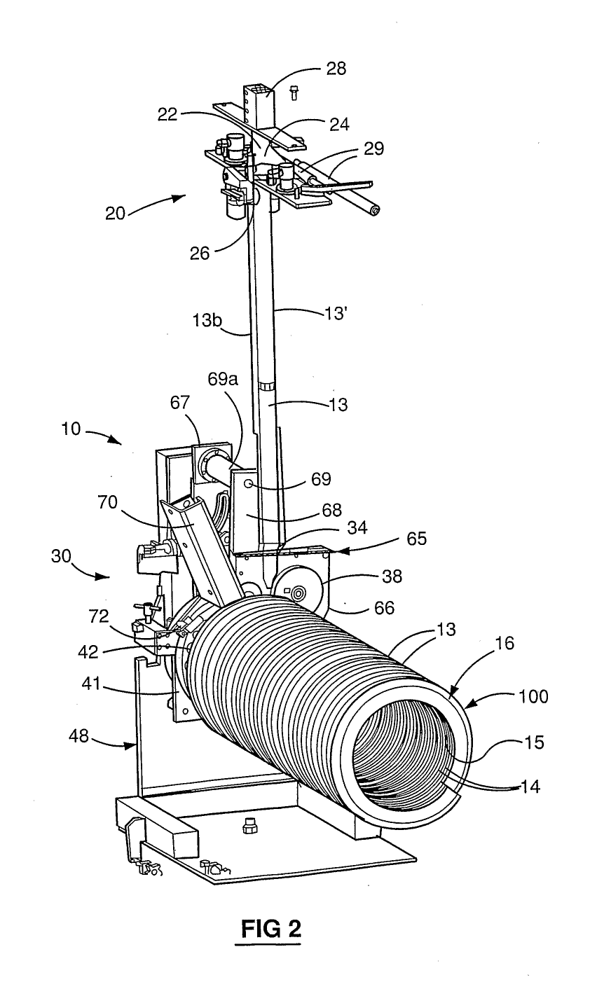

FIGS. 2 and 5 best illustrate the structure of the duct 100 formed as an assembly of helically wound components 14, 17 and 13. The inner layer 15 has captured the reinforcement wire 17 and the outer layer 16 is a continuous helical convolution of the insulating tube 13 firmly adhered to the inner layer 15. Successive windings of the tube 13 are in firm contact but are not adhered together, thereby enhancing the flexibility of the duct. When a sufficient length of duct has been formed, for example a 6 metre length, a controller provided with the illustrated apparatus initiates a timed sequence of operations to sever the duct. Delivery of the fibrous insulating material along pipe 22 is stopped for a full winding at the mandrel, and the reinforcement wire 17 is cut at or downstream of wire feed device 60 and temporarily withheld behind the cut.

Without its internal air stream and its core of fibrous insulating material, the tube flattens under the weight of press-wheel 38 as it forms the next winding. Duct severing unit 70 has a blade 71 (FIG. 3) that is linearly moved radially of the duct axis to engage and pierce the flattened winding of the duct. As the mandrel rolls continue to rotate, blade 71 tracks the centreline of the full circumference of the flattened winding, so forming a helical cut. A second severing unit 72 with its blade aligned parallel to the mandrel axis then cuts the duct parallel to the axis to join the two ends of the helical cut and the duct is now severed. The delivery of the fibrous insulating material 18 and of the wire 17 are both restored and production continues with the formation of the next length of duct.

Duct severing unit 70 is mounted for manual adjustment of its position along a sector slot 75.

It is found that the length of duct formed by the illustrated apparatus can be compressed axially in the ratio 6:1. This is achievable because the thin inner layer is readily collapsible parallel to its axis without damage, the form of the insulation as loose fibrous material 18 permits the necessary compression of the windings of tube 13 in the axial direction, and this is further facilitated by the perforation of the tube 13 to allow expulsion of air (and its readmission on expansion of the tube).

The presence of the perforations in the tube 13 means that, in the duct illustrated, moisture can come into contact with the fibrous insulation. If this is undesirable for some applications, a further layer may be applied about the second layer 16 in the form of an envelope or casing of a suitable moisture-impermeable material. This may be drawn on in a separate operation or formed on winding station 30 by helically winding on a strip to form the outer layer. The envelope or casing would typically not be positively bonded to layer 16.

A suitable wire feed apparatus to form wire feed device 60, and including a facility for severing and temporarily withholding reinforcing wire 17, is disclosed in applicant's international patent publication WO 2005/106308. A suitable apparatus to form mandrel assembly 32 is disclosed in international patent publication WO 2006/000051, with one modification, that international patent publication describes that only one of the cantilever rolls is directly driven and that the rest are idler rolls. In the present construction, it remains true that only one (42a) of the cantilever rolls is directly coupled by a suitable transmission drive system 44 to a motor unit 43, but the remaining cantilever rolls are more positively driven by a drive belt 45 engaging about the inner ends 46 of all of the rolls including the primary driven roll 42a.

The disclosures of WO 2005/106308 and WO 2006/000051 are incorporated herein by reference.

As used herein, except where the context requires otherwise the term ‘comprise” and variations of the term, such as “comprising”, “comprises” and “comprised”, are not intended to exclude other additives, components, integers or steps.

1. A flexible duct comprising:
a first, inner layer that includes multiple helical windings of a strip of thin flexible material;
a second layer overlying and adhered to said first, inner layer and including multiple helical windings of a tube containing insulating material; and
a helically wound reinforcing element.

2. The flexible duct of claim 1 wherein at the outer periphery of each winding the tube is substantially unstretched and uncompressed circumferentially and at the inner periphery the tube is puckered circumferentially.

3. The flexible duct of claim 1 wherein the insulating material is a mass of loose fibrous material.

4. The flexible duct of claim 3 wherein the tube is air permeable.

5. The flexible duct of claim 1 wherein adjacent windings of the tube are not adhered together.

6. The flexible duct of claim 1 wherein the reinforcing element is captured between overlapping portions of adjacent windings of the first, inner layer.

7. The flexible duct of claim 1 further including a third, outer layer comprising a moisture impermeable envelope.

8. The flexible duct of claim 1 wherein the tube is air permeable.

9. The flexible duct of claim 1 wherein the thin flexible material of the first, inner layer is polyester.

10. The flexible duct of claim 1 wherein the tube is formed of flexible polymer plastics.

11. The flexible duct of claim 10 wherein the tube is formed of polyester, polyethylene or polypropylene.

12. The flexible duct of claim 1 wherein the duct is compressible axially in the ratio of at least 4:1.

13. A method of forming a flexible duct including helically winding a tube containing insulating material, wherein the tube is delivered into its initial winding at a rate of delivery so that at the outer periphery of the winding the tube remains substantially unstretched and uncompressed circumferentially, while at the inner periphery the tube is allowed to pucker circumferentially.

14. The method of claim 13 wherein the rate of delivery is achieved by engaging the outer periphery with at least one press wheel that drives the outer periphery onto a mandrel assembly that helically winds the tube to form the duct, the rates of rotation of the press wheel and mandrel assembly being synchronised.

15. The method of claim 13 further including the steps of drawing a strip of flexible material relatively laterally of and into a forming head that delivers the strip forwardly from the forming head as a tubular casing in the direction of the axis of the casing, and delivering fibrous insulating material into said tubular casing at said forming head as a gas-entrained stream of the material, whereby to form said tube containing insulating material.

16. The method claim 15 wherein the flexible material of the strip is air permeable.

17. An apparatus for forming a flexible duct, the apparatus comprising:
a mandrel assembly to helically wind a tube containing insulating material;
means for engaging the outer periphery of the tube to drive it onto the mandrel assembly; and
means for synchronizing said engagement means with the rate of rotation of the mandrel assembly so that at the outer periphery of the winding the tube remains substantially unstretched and uncompressed circumferentially, while at the inner periphery the tube is allowed to pucker circumferentially.

18. The apparatus of claim 17 including a press wheel forming the engagement means.

19. A method of forming an insulating tube, including the steps of:
drawing a strip of flexible material relatively laterally of and into a forming head that delivers the strip forwardly from the forming head as a tubular casing in the direction of the axis of the casing; and
delivering fibrous insulating material into said casing at said forming head as a gas-entrained stream of the material.

20. The method of claim 19 further including bonding together edge margins of the strip as the tubular casing is delivered forwardly.

21. The method of claims 19 wherein the flexible material of the strip is air permeable.

22. An apparatus for forming an insulating tube, including:
a forming head;
means for drawing a strip of flexible material relatively laterally of and into the forming head, which is configured for delivering the strip forwardly from the forming head as a tubular casing in the direction of the axis of the casing; and
means for delivering fibrous insulating material into said casing at said forming head as a gas-entrained stream of the insulating material.

23. The apparatus of claim 22 further including means for bonding together edge margins of the strip as the tubular casing is delivered forwardly.

24. A method of forming a flexible duct including:
drawing a strip of flexible material relatively laterally of and into a forming head that delivers the strip forwardly from the forming head as a tubular casing in the direction of the axis of the casing, and delivering fibrous insulating material into said tubular casing at said forming head as a gas-entrained stream of the material whereby to form a tube containing insulating material;
helically winding a strip of flexible material into multiple windings as a first, inner layer;
helically winding said tube to form a second layer overlying and adhered to the inner layer, wherein the tube is delivered into its initial winding at a rate so that at the outer periphery of the winding the tube remains substantially unstretched and uncompressed circumferentially, while at the inner periphery the tube is allowed to pucker circumferentially; and
helically winding a reinforcing element associated with said first and/or second layer.

25. The method of claim 24 wherein the rate of delivery is achieved by engaging the outer periphery with at least one press wheel that drives the outer periphery onto a mandrel assembly that helically winds the tube to form the duct, the rates of rotation of the press wheel and mandrel assembly being synchronised.

26. The flexible duct of claim 4 wherein the duct is compressible axially in the ratio of at least 4:1.
